(19) United States
(12) Patent Application Publication
(10) Pub. No.: US 2007/0272104 A1
(43) Pub. Date: Nov. 29, 2007

(54) Coating device

(75) Inventor: Joseph T. Burgio, Palmyra, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Aradiant, Palmyra, PA (US)

(21) Appl. No.: 11/800,354

(22) Filed: May 4, 2007

Related U.S. Application Data
(60) Provisional application No. 60/798,023, filed on May 5, 2006.

(51) Int. Cl. B41K 1/38

(52) U.S. Cl. 101/335

(57) ABSTRACT

A coating device for a printing press, comprises an anilox or other metering cylinder for ink or other coating material. A softer idler roller runs in contact with the metering cylinder and with a plate cylinder to transfer the ink or other coating material from the metering cylinder to the plate cylinder. The idler roller is sufficiently soft to accommodate normal unevennesses in the metering cylinder and the plate cylinder.

### CROSS-REFERENCE TO RELATED APPLICATION

This application claims benefit of U.S. Provisional Patent Application No. 60/798,023, filed May 5, 2006, which is incorporated herein by reference in its entirety.

### BACKGROUND

The invention relates to applying coatings to materials being printed.

In offset lithographic printing (sometimes referred to as “offset litho,” “litho” or simply “offset” printing), the image-bearing “plate cylinder” has a smooth surface with a pattern of hydrophobic and hydrophilic surface areas. The surface of the cylinder is dampened with water, which wets only the hydrophilic areas, and then inked with an oil-based ink that adheres only to the dry, hydrophobic areas. The ink image is transferred by contact from the plate cylinder to a soft rubber “blanket” on the surface of a “blanket cylinder,” from which the ink is transferred to the paper, card, board, or other material being printed. The stock being printed is supported on an impression cylinder facing the blanket cylinder. The ink, which is typically in the form of a thick paste, is metered onto the plate cylinder by a system of cylinders. By adjusting the tension and speed of the inking cylinders, precise control over inking is possible, even while the press is running. However, the amount of ink that can be applied in one pass is limited.

In flexographic printing (sometimes referred to as “flexo” printing), the plate cylinder has a surface with raised and lowered areas, the raised areas usually forming the image (although an intaglio system in which the recessed areas form the image is possible). The ink, which is typically thin enough to be poured, is applied to the plate cylinder by an “anilox” cylinder, which has a hard surface, usually ceramic, etched with an array of pits. The pits are filled with ink, and then the surface is wiped clean, so the anilox cylinder acts as a metering cylinder, delivering an amount of ink determined by the volume of the pits. Flexo printing allows larger quantities of ink or other medium to be applied in one pass. However, the amount of ink delivered can be changed only by changing the anilox cylinder. Flexo printing units are tricky to set up, because both the anilox cylinder and the plate cylinder are hard, so a good, even contact between them is difficult to achieve, especially if one of the cylinders is out of true or is slightly damaged.

U.S. Pat. No. 5,178,678 in the name of Koehler et al., which is incorporated by reference in its entirety, describes a coater assembly used as an add-on to an offset litho printing system. An anilox cylinder applies coating to a coating blanket cylinder, which transfers the coating to the blanket cylinder of the last offset printing unit. Alternatively, the coating blanket cylinder transfers the coating directly to the stock, an accessible transport cylinder being replaced by an additional impression cylinder facing the coating blanket cylinder. The coating blanket cylinder has a ring gear, which is driven from a ring gear on the offset blanket cylinder or additional impression cylinder.

Koehler's device, because it requires access to an offset blanket cylinder or to a transport cylinder that can be replaced, is in most printing presses only suitable for applying an overcoat in place of or after the last print stand. In addition, Koehler's device relies on transfer from the anilox cylinder to one or more blanket cylinders, so is not suitable for applying a patterned coating.

It is not practical to use a blanket cylinder as a plate cylinder or vice versa. For the various cylinders to run together without slipping, the outside diameter must be exactly controlled. The diameter is standard, to allow printing plates to be prepared without specifying the individual printing press. The blanket is typically soft, and around 77 to 125, commonly 90 to 120, thousandths of an inch (2 or 3 mm) thick. The printing plates are typically hard and around 20/1000 inch (0.5 mm) thick. As a result, the core diameters of the cylinders are slightly different. For low-definition printing, a plate made of soft material can be put onto a plate cylinder, for example, some printing plates have a hardness as low as 35 to 40 Shore A. Finer definition typically requires harder plates. However, practical tolerances mean that the distances by which the surface need to deflect are not small compared with 0.5 mm. As a result, the hard, usually steel, surface underneath becomes noticeable, and the effective hardness of the plate on the cylinder is much higher than the nominal hardness of the plate material on its own. A specially constructed extra-thick printing plate can be mounted on the core of a blanket cylinder, but such special plates are expensive. Also, on many commercially available presses the plate cylinders have a mechanism to adjust the individual cylinders forwards or backwards by small, precisely controlled amounts to ensure correct registration between different stations in a multi-color printing operation. Additionally, the clamp to hold the printing plate is typically segmented to allow skewing of the printing plate on the plate cylinder. The blanket cylinders do not usually need, and are not usually provided with, similar adjustment mechanisms.

There is therefore a hitherto unfilled need for a coating device that can be installed in an offset litho press, that allows patterned coatings, and that can be positioned at any desired position, including between litho print stands. Such a device can then be used, for example, to apply an opaque undercoat for subsequent printing, or for printing details that require a thick ink, such as metallic details.

### SUMMARY

According to one embodiment of the invention, there is provided a coating device for a printing press, comprising: a metering cylinder for ink or other coating material; and an idler roller running in contact with the metering cylinder and arranged in use to run in contact with a printing plate on a plate cylinder to transfer the ink or other coating material from the metering cylinder to the plate cylinder; wherein the idler roller is sufficiently soft to accommodate normal unevennesses in the metering cylinder, the printing plate, and the plate cylinder.

According to one embodiment of the invention, there is provided a coating device for a printing press, comprising an anilox cylinder with a soft idler cylinder running in contact with the anilox cylinder and with a plate cylinder. The anilox cylinder is positively driven with a peripheral speed matching the peripheral speed of the plate cylinder. The idler cylinder can be driven by friction from the anilox cylinder and the plate cylinder. In another embodiment, the idler cylinder can be positively driven by transmission from the anilox cylinder, or by its own drive. The idler cylinder is appreciably softer than the plate cylinder and the anilox cylinder, and preferably sufficiently soft to accommodate any unevenness in the plate cylinder or the anilox cylinder resulting from manufacturing tolerances or from normal wear and tear.

In an embodiment, the anilox cylinder has a diameter of about 4″ (10 cm), the idler cylinder has a diameter of about 2″ (5 cm) and the plate cylinder has a diameter of about 12″ (30 cm).

In an embodiment, the plate cylinder is a plate cylinder for a print stand of an offset press. The anilox cylinder and the idler cylinder are retractable away from the plate cylinder to allow use of the print stand for offset printing. The dampening and inking units for offset printing can be backed out of contact with the plate cylinder for coating. Many commercially available offset presses have easy access to part of the circumference of the plate cylinder, for example, through an opening provided for installation and removal of the plate cylinder. The plate cylinder is usually easily accessible, to allow for the plates to be changed, especially on presses intended for relatively short print runs.

A lithographic printing plate may be used for offset printing, and a flexographic or other relief printing plate may be used for flexographic printing.

In an embodiment, the coating unit comprises a single carrier for the idler cylinder, the anilox cylinder, and an inking system for the anilox cylinder. Then, when the coating unit is brought into and out of use, the fragile anilox cylinder is cocooned between the inking system and the idler cylinder, and is largely protected from damage.

In another embodiment, a retractable carrier device is incorporated such that the actual coating unit can be easily removed from the retractable carrier and placed onto another retractable carrier. In this manner, one coating device can be quickly removed and placed on another printing unit that is equipped with a carrier device.

According to another embodiment of the invention, there is provided an offset printing press, especially a sheet-fed offset press, including at least one coating or flexographic print stand. The same device can be used with web type offset printing presses. In a preferred embodiment, the coating or flexographic print stand is positioned between two offset print stands, relative to the path of the sheets through the press.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic side elevational view of a sheetfed, offset printing press according to an embodiment of the present invention.

FIG. 2 is an enlarged detail of part of FIG. 1.

### DETAILED DESCRIPTION

Reference will now be made in detail to various embodiments of the present invention, examples of which are illustrated in the accompanying drawings.

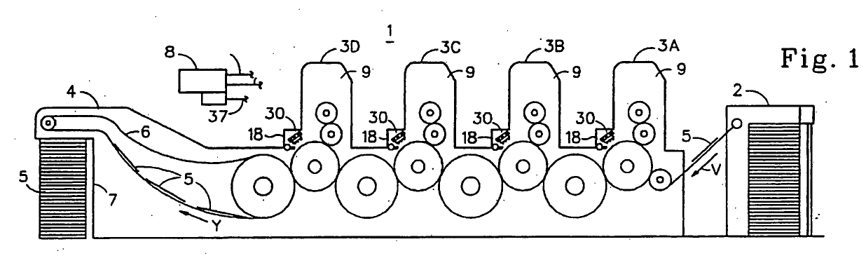

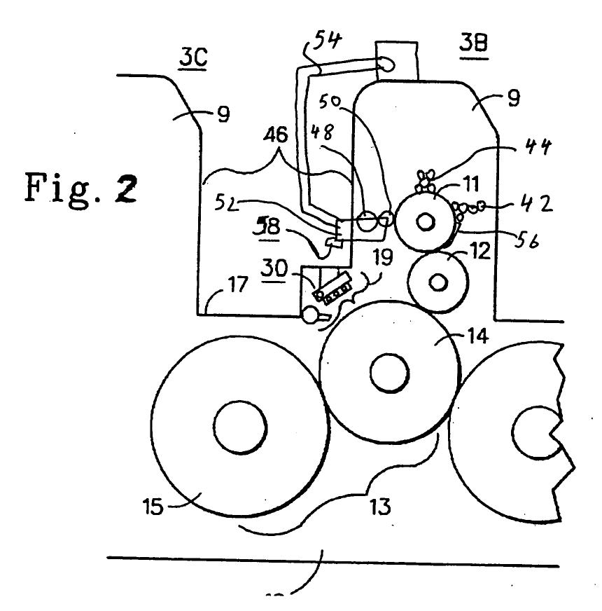

Referring to the drawings, and initially to FIGS. 1 and 2, there is shown an offset, sheetfeed printing press 1 that provides for printing and coating of sheets 5 moving in direction V, from a supply feeder 2. After coating and printing is performed, in the manner described below, the sheets 5 are directed to a stacker 7 by a delivery-end feed chain 6 with the sheets moving in direction Y. The printing press 1 is similar to the press described in U.S. Pat. No. 5,727,472 (to Burgio), which is incorporated herein by reference in its entirety.

Printing press 1 includes print stands 3A, 3B, 3C, and 3D . . . each providing for application of a printing ink to the sheets 5. The number of print stands may vary from press to press. The print stands are spaced along the press 1 between the feeder 2 and the stacker 7. Each of the print stands 3A-3D includes an impression cylinder 14 and a transfer cylinder 15 arranged such that an interconnected series of cylinders 13 is formed. Each of the print stands 3A-3D further includes a plate cylinder 11 and a blanket cylinder 12. Each of the print stands 3A-3D is provided with a dampening unit 42 and an inking unit 44 acting on the plate cylinder 11 for offset printing using a lithographic plate on the plate cylinder 11. The ink image on the plate cylinder 11 is transferred by rolling contact to the blanket cylinder 12. The sheets 5 are directed by the printing press 1 between the blanket cylinder 12 and the impression cylinder 14 of each of the printing stands where pressure therebetween results in transfer of ink from the blanket cylinder 12 to the sheets 5. The transfer cylinders 15 transport the sheets 5 to and from the impression cylinders 14. The printing press 1 further includes a drying assembly 30 positioned adjacent each of the print stands 3A-3D. The construction and operation of the drying assemblies 30 is described in greater detail in U.S. Pat. Nos. 5,727,472 and 5,832,833 (both to Burgio), which are incorporated herein by reference.

Referring now especially to FIG. 2, at least one of the printing stands (3B is shown) is provided with a coating unit 46 that includes an anilox cylinder 48 and an idler roller 50. An inking unit 52 applies ink to the anilox cylinder 48. The inking unit 52 may be of various types including a type already known. For example, the inking unit may use a simple wiper blade, or an anilox chamber. An enclosed anilox chamber with a metal metering blade and a metal wiper blade may be used. The quantity of ink applied is determined by the number and size of the recesses in the surface of the anilox cylinder. The anilox cylinder 48, idler roller 50, and inking unit 52 are movable as a single unit towards and away from the plate cylinder 11 by a carrier 54. When the coating unit 46 is not in use, the carrier 54 may retract that single unit to a position where the coating unit does not obstruct other operations, for example, as shown in FIG. 2, to a position on top of the print stand 3B. In particular, the coating unit 46 in its retracted position does not obstruct access to the plate cylinder 11 when changing a printing plate 56 on that cylinder.

The plate 56 may be a metal offset printing plate, typically 0.012″ (0.3 mm) thick, or a thin flexographic printing plate, typically 0.020″ to 0.045″ (0.5 to 1.15 mm) thick, and made of rubber or similar material.

The dampening unit 42 and the inking unit 44 are arranged to be moved out of contact with the plate cylinder 11 when the coating unit 46 is in use. The dampening unit 42 and the inking unit 44 are then not contaminated with coating material. The dampening unit 42 and the inking unit 44, which are designed for use with a smooth-surfaced lithographic plate, are then not exposed to the possibility of damage where a relieved flexo plate is used with the coating device 46. The movement of the dampening unit 42 and the inking unit 44 is typically within the normal range of adjustment of those units.

In the embodiment shown in FIG. 2, the anilox cylinder 48 is about 4″ (10 cm) in diameter, and the plate cylinder 11 is about 12″ (30 cm) in diameter. The idler roller 50 may then be about 2″ in diameter. The small diameter of the idler roller 50 enables the coating unit 46 to be installed in many commercially available printing presses 1. The anilox cylinder 48 is positively driven, for example, by an electric motor 58 that is electronically synchronized with the motor or motors driving the printing press 1, so that the peripheral speed of the anilox cylinder is substantially the same as the peripheral speed of the plate cylinder 11, and the two cylinders are rotating in the same direction. The idler roller 50 is driven by friction from its contact with the plate cylinder 11 and the anilox cylinder 48. The textured surface of the anilox cylinder 48 engaging the soft surface of the idler roller 50 provides an almost perfect friction drive. Any difference in the peripheral speeds of the anilox cylinder 48 and the plate cylinder 11 then results in slippage between the plate cylinder 11 and the idler roller 50. Any slippage may cause increased wear of the idler roller 50 and/or imperfect inking of the plate 56 on the plate cylinder 11.

The idler roller 50 is made of, or surfaced in, a soft material, such as rubber or other elastomer. In a practical embodiment, the idler roller 50 may have a surface of 0.5″ (12.5 mm) thick or thicker Ethylene Propylene Diene Monomer (EPDM) rubber or polyvinylchloride (PVC) nitrile rubber with a hardness of between 25 and 40 Shore A. The softness of the idler roller 50 accommodates departures from round as a result of manufacturing tolerances in the anilox cylinder 48, the plate cylinder 11, and the printing plate 56, and as a result of minor damage to any of those components. In addition, the idler roller 50 reduces the risk of damage to those components, especially to the anilox cylinder 48, which may be of ceramic material and therefore somewhat brittle. If the idler roller 50 were not provided, it would be necessary for the anilox cylinder 48 to bear directly on the hard printing plate 56. However, a contact sufficiently even to ensure reliable, uniform transfer of ink or other coating material would require tolerances finer than the manufacturing tolerances of typical commercial plate cylinders.

In addition, the plate cylinder 11 and the plate 56 may become slightly damaged in use. For example, in non-offset printing in which the sheets 5 contact the plate cylinder 11, the plate cylinder may be slightly dented if an unusually thick sheet, or two sheets together, pass through the press. A dent of 0.001″ (25 μm) or even less where ink is transferred between hard cylinders may result in a gap in the ink coating on the plate 56. Where the width of the press, which is the length of the cylinders and thus the length of the line of contact between engaging cylinders, is commonly 40″ (1.2 m) or even longer, if most of the length of two contacting hard cylinders is a good match, the closing force required to compress the cylinders to close a 25 μm dent is impractically high.

In addition, without the idler roller 50 there would be a material risk of damage, especially to the anilox cylinder 48, as the two cylinders were brought into contact.

In operation, the press 1 may be used as a standard offset litho press, with litho plates on all plate cylinders 11, with the dampening units 42 and the inking units 44 in operation, and with any coating units 46 retracted. The number of colors that can be applied in one pass is then determined by the number of print stands 3A, 3B, 3C, 3D . . . . If it is desired to include a coating stage in the printing process, then the appropriate print stand, for example, print stand 3B, is selected. The dampening unit 42 and the inking unit 44 are adjusted to a position out of contact with the plate cylinder 11. The litho plate 56 is replaced with a flexo plate 56, for patterned coating, or a plain plate 56, for uniform coating. For easier changing of the printing plate 56, the plate cylinder 11 may be removed with the outgoing plate, and reinserted after the incoming plate has been mounted on the cylinder. Because the flexo plate 56 is mounted on one of the plate cylinders 11, a standard thin printing plate can be used, which is economical.

The coating unit 46 is then advanced into position with the idler roller 50 pressing sufficiently firmly on the plate cylinder 11 that the whole image area of the plate 56 receives a proper application of coating material. The softness of the idler roller 50 allows the hard anilox cylinder 48 to cooperate with the hard printing plate 56. The anilox cylinder 48 is charged with the appropriate ink or coating material by the inking unit 52. The patterned coating is brought into register with the printing from the other print stands 3A, 3C, 3D . . . in the usual way. Because the coating plate 56 is on one of the normal plate cylinders 11 of the printing press 1, it can be aligned in exactly the same way as the other plates 56 on the press 1.

A combined offset and flexographic printing process is then possible, with each print stand 3A, etc. printing or coating the sheets 5 depending on how the individual print stand is configured. The coating devices 46 may be used for undercoats, overcoats, spot printing of metallic inks, or other applications of inks or coatings that require a heavier application than is readily achieved with offset printing.

Various modifications and variations can be made in the present invention without departing from the spirit or scope of the invention. Thus, it is intended that the present invention cover modifications and variations of this invention provided they come within the scope of the appended claims and their equivalents.

For example, in FIG. 2 a single coating device 46 is shown attached to the second print stand 3B of a four color press 1. The press 1 may have more or fewer than four print stands. The coating device 46 may be attached to a different print stand, or may be movable from one print stand to another, or more than one print stand may be equipped with a coating device 46.

The coating device 46 is shown as an alternative device on a plate cylinder 11 that is also equipped with a lithographic dampening unit 42 and inking unit 44. Alternatively, the coating device 46 could be on a dedicated print stand. Many of the advantages mentioned above will still apply. In particular, an anilox cylinder can be used for metering flexo ink or coating in combination with a standard thin relief printing plate 56 mounted on a standard-size plate cylinder 11.

Although the material applied with the coating device 46 has been variously described as “coating” or “ink,” the distinction is for most purposes not important, as long as the material has in its wet state the appropriate mechanical properties for application with the “coating” device 46.

What is claimed is:

1. A coating device for a printing press, comprising:
a metering cylinder for ink or other coating material; and
an idler roller running in contact with the metering cylinder and arranged in use to run in contact with a printing plate on a plate cylinder to transfer the ink or other coating material from the metering cylinder to the plate cylinder;
wherein the idler roller is sufficiently soft to accommodate normal unevennesses in the metering cylinder, the printing plate, and the plate cylinder.

2. A coating device according to claim 1, wherein the metering cylinder is not sufficiently soft to accommodate normal unevennesses in the plate cylinder if the metering cylinder and the plate cylinder were in direct contact.

3. A coating device according to claim 1, wherein the metering cylinder is an anilox roller.

4. A coating device according to claim 1, further comprising a drive for the metering cylinder arranged in use to drive the metering cylinder with a peripheral speed matching the peripheral speed of the plate cylinder.

5. A coating device according to claim 1, wherein the idler roller is driven by friction from the metering cylinder.

6. A coating device according to claim 1, further comprising a drive for the idler roller.

7. A coating device according to claim 1, further comprising the plate cylinder.

8. A coating device according to claim 7, further comprising a dampening unit and a lithographic inking unit in cooperation with the plate cylinder for lithographic printing from the plate cylinder.

9. A coating device according to claim 7, wherein the metering cylinder and the idler roller are retractable away from the plate cylinder.

10. A coating device according to claim 1, further comprising a single carrier for the idler roller, the metering cylinder, and an inking system for the metering cylinder.

11. An offset printing press including at least one coating or flexographic print stand movable into a position engaging a plate on a plate cylinder of the offset press.

12. An offset printing press according to claim 11 including at least two coating or flexographic print stands each movable into a position engaging a plate on a respective one of the plate cylinders of the offset press.

13. An offset printing press according to claim 12 including respective coating or flexographic print stands movable into positions engaging plates on each of the plate cylinders of the offset press.

14. An offset printing press according to claim 12 wherein at least two of the plate cylinders of the offset press are provided with movable carriers for coating or flexographic print units, and at least one coating or flexographic print unit transferable between the at least two movable carriers.

15. An offset printing press according to claim 11 that is sheet-fed.

16. An offset printing press according to claim 11 that is web-fed.

17. An offset printing press according to claim 11 wherein the coating or flexographic print stand is positioned between two offset print stands, relative to the path of the sheets through the press.

18. An offset printing press according to claim 11, wherein at least one said coating or flexographic print stand comprises a plate cylinder that is also operable as a plate cylinder of an offset print stand.

19. An offset printing press according to claim 18, further comprising a dampening unit and a lithographic inking unit in cooperation with the plate cylinder for lithographic printing from the plate cylinder.

20. An offset printing press according to claim 19, wherein the dampening unit and the lithographic inking unit are retractable away from the plate cylinder.

21. An offset printing press according to claim 11, wherein at least one said coating or flexographic print stand comprises:
a plate cylinder;
a metering cylinder for ink or other coating material; and
an idler roller running in contact with the metering cylinder and with the plate cylinder to transfer the ink or other coating material from the metering cylinder to the plate cylinder;
wherein the idler roller is sufficiently soft to accommodate normal unevennesses in the metering cylinder and the plate cylinder.

22. An offset printing press according to claim 21, wherein the metering cylinder is not sufficiently soft to accommodate normal unevennesses in the plate cylinder if the metering cylinder and the plate cylinder were in direct contact.

23. An offset printing press according to claim 21, wherein the metering cylinder is an anilox roller.

24. An offset printing press according to claim 21, further comprising a drive for the metering cylinder arranged in use to drive the metering cylinder with a peripheral speed matching the peripheral speed of the plate cylinder.

25. An offset printing press according to claim 21, wherein the idler roller is driven by friction from at least one of the metering cylinder and the plate cylinder.

26. An offset printing press according to claim 21, wherein the metering cylinder and the idler roller are retractable away from the plate cylinder.

27. An offset printing press according to claim 21, further comprising a single carrier for the idler roller, the metering cylinder, and an inking system for the metering cylinder.

28. An offset printing press comprising:
plate cylinders arranged to carry printing plates; and
mobile anilox cylinder coating devices incorporating an idler roller between the anilox cylinder and the plate cylinder.
